(19) United States
(12) Patent Application Publication
(10) Pub. No.: US 2022/0108599 A1
(43) Pub. Date: Apr. 7, 2022

(54) DISASTER RELIEF HUB BOX SYSTEM

(71) Applicant: Chris Hart, Ivins, UT (US)

(72) Inventor: Chris Hart, Ivins, UT (US)

(21) Appl. No.: 17/490,254

(22) Filed: Sep. 30, 2021

Related U.S. Application Data
(60) Provisional application No. 63/086,143, filed on Oct. 1, 2020.

(51) Int. Cl. G08B 25/01; A45C 11/00; A45C 13/02; A45C 13/00; H02J 7/35

(52) U.S. Cl. CPC G08B 25/016; A45C 11/00; A45C 13/02; A45C 2011/002; H02J 7/35; A45C 2011/007; A45C 2011/003; A45C 13/005

(57) ABSTRACT

A disaster relief hub box system includes a hub box, instructions, and damage assessment materials. The hub box may comprise a door that is hingedly coupled to the hub box. To open the door, a user may use a key or coin to turn a lock. Once the door is opened, clipboards with instructions, a radio, and the damage assessment form may be provided to community members to organize the community and address any emergency situation. The hub box may be opened by any individual without the need of a key, allowing it to be accessible to anyone day or night. To deter vandalism and notify community members of a possible emergency, an alarm may be positioned inside the hub box and activated when the door is opened.

### CROSS-REFERENCE TO RELATED APPLICATIONS

This application claims the benefit of U.S. Provisional Application Ser. No. 63/086,143 filed on Oct. 1, 2020, which is incorporated herein by reference.

### TECHNICAL FIELD

The present disclosure relates to a disaster relief box. More particularly, the present disclosure relates to a disaster relief hub box that provides communities with instructions, components, and items necessary for organization and aid in emergency situations.

### BACKGROUND

The Federal Emergency Management Agency (FEMA) under its Community Emergency Response Team (CERT) Program describes three “Tiers” of preparation necessary to effectively deal with a disaster. “Tier One” is “Individual & Family” preparation for such an event; “Tier Two” is “Community Organization” designed to provide mutual assistance; and “Tier Three” is “Local Government” whose responsibility it is to establish an Emergency Operations Center through which a disaster response is coordinated and outside assistance obtained.

Most communities have disaster plans in place and many individuals and families have prepared themselves for an emergency situation. Disaster response programs almost always fail, however, at the Tier Two or Community Organization level, in part, because it requires a large number of citizen volunteers who are willing to accept the responsibility to oversee an Area, Zone, or Block, and commit the time to be trained to perform specific functions both pre- and post-disaster event. With the time and training commitment, many people decline to accept such responsibility. Even when a community invests extensive time, effort, and expense to successfully organize itself at the Tier Two level, that organization tends to deteriorate over time as key players move away or lose interest and there is not a general, easy to follow disaster plan in place.

The Rapid Disaster Assessment Kit or “RDAK” was created in recognition of the previously presented problems. RDAK established a means whereby untrained individuals could assemble at an established gathering location post-event where they would receive binders filled with instructions and forms to assist them while they participated in the damage assessment process. It also provided a radio for them to use to communicate the information they gathered to an up-line coordinator. RDAK is currently the preferred Tier Two disaster planning program and has been adopted by many communities across the country.

However, the main problem with RDAK is that the gathering locations are usually public buildings, schools, or churches that are often too far away for some volunteers to access easily. These facilities also require someone with a key to provide access, and if that person is away or injured, or the building itself suffers major damage or is destroyed during the event, the needed contents of the RDAK container become inaccessible and radio communication unattainable.

Accordingly, there is a need for a system that provides essential emergency instructions and tools, allows lay individuals to access these instructions and tools in numerous locations without a key, and allows individuals to address emergency situations efficiently and in an organized manner. The present disclosure seeks to solve these and other problems.

### SUMMARY OF EXAMPLE EMBODIMENTS

In some embodiments, a disaster relief hub box comprises instructions and damage assessment materials. The hub box may comprise a door that is hingedly coupled to the hub box. To open the door, the hub box may comprise a turn lock. The hub box may be made of a metal material, such as a weatherproof powder coated steel. Alternatively, the hub box may comprise a non-metal material, such as treated wood, fiberglass, plastic, carbon fiber, etc. The hub box may be opened by any individual without the need of a key, allowing it to be accessible to anyone day or night. The instructions may comprise external instructions, first-to-arrive instructions, volunteer instructions, and others.

In some embodiments, to reduce tampering, the hub box may comprise an alarm that is triggered when the door is opened. In some embodiments, the alarm may automatically cease after a predetermined amount of time. In some embodiments, the instructions for the first-to-arrive explain how to shutoff the alarm.

In some embodiments, the disaster relief hub box comprises a solar panel coupled to the hub box.

In some embodiments, the disaster relief box comprises a micro surveillance camera.

### BRIEF DESCRIPTION OF THE DRAWINGS

FIG. 1 illustrates an external, front perspective view of a disaster relief hub box;

FIG. 2 illustrates a front perspective view of a disaster relief hub box in an opened configuration;

FIG. 3 illustrates a front, top perspective view of a disaster relief hub box comprising solar panels.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need for a system that provides essential emergency instructions and tools, allows lay individuals to access disaster boxes in numerous locations without a key, and allows those individuals to address emergency situations efficiently and in an organized manner. The disaster relief hub box disclosed herein seeks to solve these and other problems.

The disaster relief hub box described herein may generally comprise damage assessment materials and instructions. The hub box may be positioned in multiple locations throughout a community, either coupled to existing posts or buildings, or coupled to a post designated for the hub box. The system allows individuals, communities, and local governments to address any disaster through an organized approach. Typically, disaster response programs are unsuccessful when a disastrous event has occurred. In particular, many individuals have to be trained to organize a disaster response, and determining the response steps to an emergency may become difficult. However, the disaster relief hub box limits the number of individuals who need to be trained, allowing for an efficient and easy to use system.

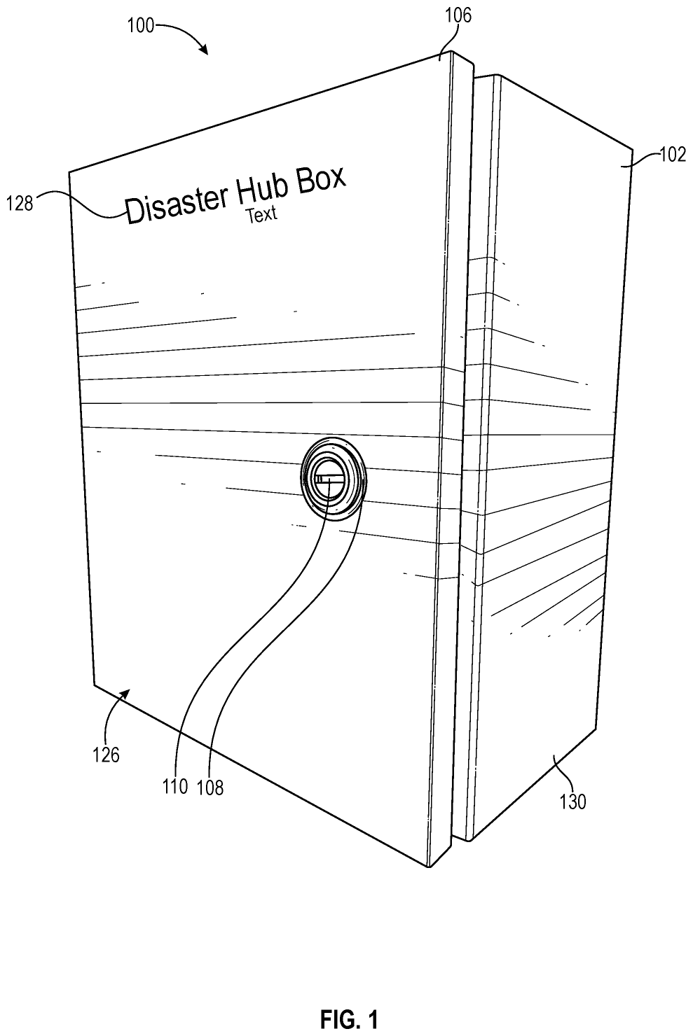

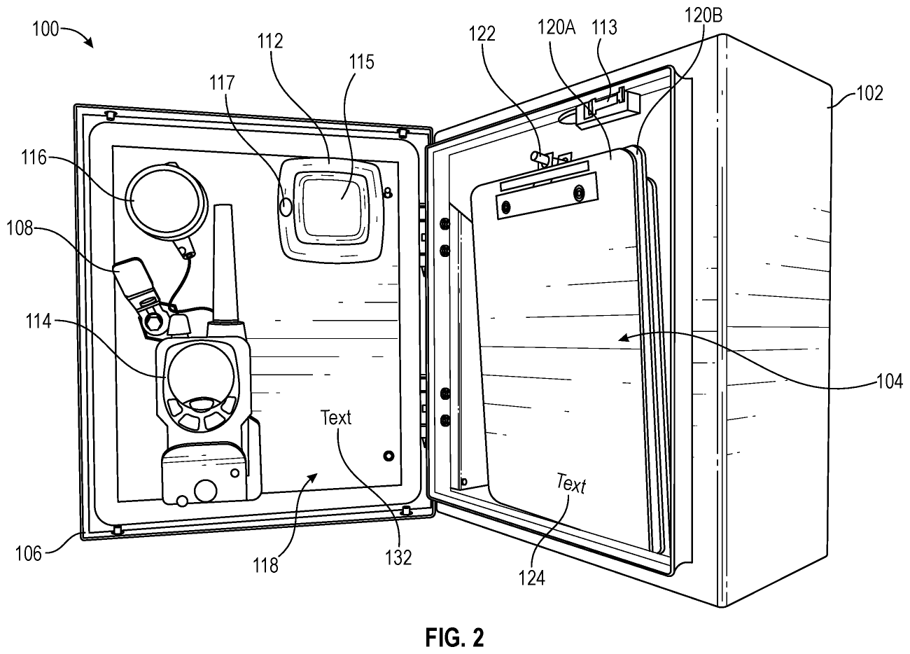

In some embodiments, as shown in FIGS. 1-2, a disaster relief hub box system 100 comprises a hub box 102 and instructions and damage assessment materials 104. The hub box 102 may be mounted on a metal post that is designated for the hub box, an existing post (e.g., power pole, streetlight, street sign, etc.), or an existing structure (e.g., building) that is in a highly visible location, which allows access regardless of the condition of surrounding buildings. The hub box 102 may comprise a door 106 that is hingedly coupled to the hub box 102. The hub box 102 may further comprise a turn lock 108 with a slot 110. To open the door 106, a user may insert a coin, knife blade, or a key into the slot 110 and turn, thereby disengaging the lock 108 and opening the door 106. This may prevent younger kids from gaining unwanted access to the box 100. While the slot 110 is shown, it will be appreciated that a handle, knob, or other mechanism may be used to disengage the lock 108. It should be noted that in some embodiments, the hub box 102 may comprise a hingedly coupled lid. Alternatively, the hub box 102 may comprise a slidable lid or door, breakable glass, or any other type of lid or door. In some embodiments, the hub box 102 may be manufactured from a metal material, such as a weatherproof powder-coated steel. In some embodiments, the hub box 102 may comprise a non-metal material, such as treated wood, fiberglass, plastic, carbon fiber, or other suitable substantially weatherproof material.

It will be appreciated that the hub box 102 may be opened by any individual without the need of a key, in contrast to the prior art, so that the hub box system 100 is accessible to anyone, day or night. In some embodiments, positioned inside the hub box 102 is an alarm 112. The alarm 112 may be triggered when the door 106 is opened so as to alert individuals in the community of a pending emergency or, alternatively, to deter vandalism or theft of the hub box 102 contents. The alarm 112 may be triggered via one or more sensors 113, such as motion detection sensors, light detection sensors, magnetic sensors, accelerometers, or other sensors. The alarm 112 may also comprise a light 115. Further, in one embodiment, the hub box 102 may comprise a micro surveillance camera 117, which may also help deter vandalism and may help document an emergency meeting. A two-way communications radio 114 with a retractable cable tether 116 may be coupled to an inner surface 118 of the door 106. The radio 114 allows a user to communicate with emergence response personnel and others. The tether 116 helps keep the radio 114 from being lost or taken from the hub box 102.

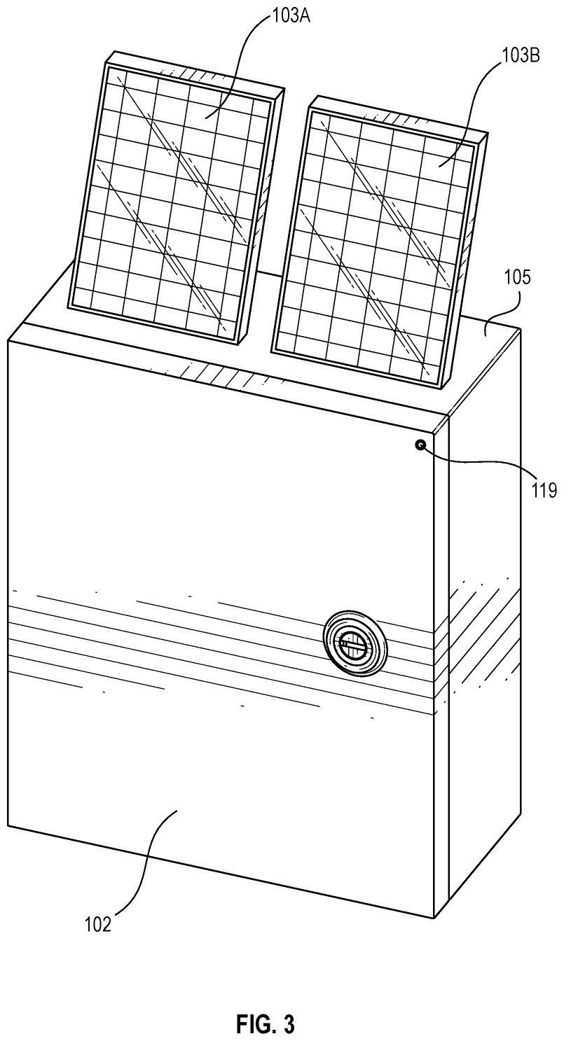

Further, the light 115 may turn on automatically when the door 106 is opened, using one or more sensors 113 acting as a switch or otherwise coupled to a switch. To charge the electronics (e.g., light, alarm, radio, etc.) in the hub box 102, power may be directly fed to the hub box 102 via power lines. Further, in some embodiments, as shown in FIG. 3, the hub box 102 includes one or more solar panels 103A, 103B that trickle charge the batteries (e.g., light, alarm, radio, extra battery, etc.). It will be appreciated that the solar panels 103A, 103B may be coupled to the hub box 102, as shown in FIG. 3, but in some embodiments, the solar panels may be directly built (integrated) into one of the surfaces, such as a top surface 105. In some embodiments, the hub box 102 may comprise one or more external LEDs 119 so as to indicate the battery status of the radio or other components on the inside. For example, the LED 119 may be illuminated red to indicate a low battery, notifying community members or leaders that the battery needs replacing or charging.

Referring to FIG. 2, the hub box 102 may comprise first-to-arrive clipboards 120A and volunteer clipboards 120B. Clipboards 120A, 120B may hang inside the hub box 102 on a rod 122. While a rod 122 is shown, it will be appreciated that a hook, or any other attachment may be used to hold and organize clipboards 120A, 120B. The first-to-arrive clipboard 120A and volunteer clipboard 120B may comprise an instruction decal attached to its back side. Additionally, each may clipboard 120A, 120B may be a different color. Clipped to the front sides may be a map, a writing instrument, and damage assessment forms for all the addresses within a specific block. The instructions found on the clipboards 120A, 120B may be different. A non-limiting example of first-to-arrive instructions 124 found on the first-to-arrive clipboard 120A, may be as follows:

### FIRST TO ARRIVE

1. Remove the BLUE clipboard from the Hub Box.
2. You will act as temporary leader until your Zone Leader arrives.
3. Carefully read the instructions on the Hub Box door.
4. Use the Radio to contact the Area Coordinator. State your name and the Zone Number printed on the side of the Hub Box.
5. Review the Zone Maps and locate the Blocks within your Zone.
6. Distribute the RED clipboards to the Volunteers as they arrive and direct them to their assigned Blocks.
7. When the volunteers return, use the radio to report to the Area Coordinator. First, state the address and then the checked condition numbers for each Damage Assessment Form on their clipboards. Do not report addresses with the “0” box checked.
8. Ask returning Volunteers to remain nearby to receive instructions on how to assist in the relief effort.
9. Repeat this process until all Blocks have been reported.
10. Mark on the Zone Map each completed Block.
11. Replace the clipboards in the Hub Box face forward with the blue clipboard in front.
12. Wait by the radio to receive instructions on how to assist those suffering injury or property damage in your Zone.
13. Assign volunteers to assist as you have been instructed.
14. Close the Hub Box only when your Zone has been stabilized.

An example of volunteer instructions may be as follows:

### VOLUNTEERS

1. Remove a RED clipboard from the Hub Box.
2. Read these instructions carefully before leaving the Hub Box.
3. Use the Block Map provided to locate your Assessment Area.
4. Proceed to your assigned Block quickly as directed.
5. Using the Damage Assessment Form for each assigned address:
   a. Assess property damage from the outside.
   b. DO NOT approach or enter a heavily damaged home.
   c. If it is SAFE, knock on the door and announce your purpose.
   d. Assess the number and condition(s) of occupants.
   e. DO NOT enter the house to search for occupants.
   f. DO NOT stop at this point to administer first aid.
   g. Check the appropriate numbered boxes on the Damage Assessment Form for this specific address.
6. Repeat this process for each assigned address in your Block.
7. Return to the Hub Box with your completed Assessment Forms.
8. Give the clipboard to the acting Zone Leader for processing.
9. Take another red clipboard and repeat the Damage Assessment process for another Block if necessary.
10. When all the Blocks in your Zone are assessed for damage:
   a. Remain near the Hub Box to receive instructions to assist with the stabilizing relief efforts underway in your Zone.
   b. Provide help as assigned consistent with your training. You may accompany a CERT Team or other First Responders or be called upon to assist individually as you are able.

In one embodiment, an outer surface 126 (FIG. 1) of the hub box 102 may comprise a decal 128 that displays relevant information, such as “Disaster Hub Box” in highly-visible letters, written instructions on how to open the hub box 102, an explanation of security features contained inside the hub box 102, and a warning stating the penalties for vandalism. Additional decals on the outer surface 126 of the hub box 102 may display a hub area reference and zone number 130. The disaster relief hub box system 100 provides convenient gathering locations, which may be called “Hubs” in neighborhoods throughout a community, allowing easy access to the hub box 102 and its materials by any individual in the community.

Lastly, referring again to FIG. 2, the inner surface 118 of the hub box 102, may be a how-to-use instruction decal 132 that provides basic instructions on how to use the materials inside the hub box 102 and detailed instructions on how to use the radio 114. An example of the how-to-use instructions 132, may be as follows:

### ALARM WILL SHUT OFF IN 10 SECONDS

### FIRST TO ARRIVE

### Follow the Instructions on the BLUE Clipboard

### ALL OTHERS

### Follow the Instructions on the RED Clipboards

### TO USE RADIO

1. Remove the radio from its mounting bracket.
2. Do NOT attempt to detach the radio from its tether.
3. If not already performed, install the batteries located inside the Hub Box.
   a. Remove the battery cover on back of radio.
   b. Insert the batteries noting correct polarity +/−.
   c. Replace the battery cover before using.
4. Turn the radio on & adjust volume using the TOP knob.
5. Select the channel by pressing the MENU button once and use the up/down arrows to locate the correct number printed on the radio's mounting bracket.
6. Press the LOCK button and hold it down for 3 seconds to lock in the frequency channel.
7. Hold the radio two to three inches from your mouth.
8. To transmit, press and hold the radio's SIDE button.
9. To receive, simply release the radio's SIDE button.

The damage assessment material may include a damage assessment form. The damage assessment form may allow community members to determine damage to the community, injuries, and the type of emergency, among other things. For example, the damage assessment form may have the following information:

### DAMAGE ASSESSMENT FORM

Address ______
Zone Block ______ Block # ______ Your Initials ______
0. Occupant(s) and Property are Unharmed.

### HARM TO OCCUPANT(S).

1. Unable to make contact with Occupant(s).
2. One or more Occupants are Deceased.
3. One or more Occupants are Seriously Injured.
4. One or more Occupants have Minor Injuries.
5. One or more Occupants are Immobile.
6. One or more Occupants suffer Health Conditions.
7. One or more Occupants require Medication(s).

### DAMAGE TO PROPERTY

8. One or more Buildings have been Destroyed.
9. Building(s) are on Fire or are Fire Damaged.
10. Building(s) are Flooding or have Flooded.
11. Building(s) are Unsafe with Major Structural Damage.
12. Building(s) are Safe with only Minor Damage.
13. Gas Line is Broken or Service is Interrupted.
14. Power Line is Down/Cut or Service is Interrupted.
15. Water Line is Broken or Service is Interrupted.
NOTES: ______

To implement the disaster relief box system 100 in a community, in one embodiment, a municipality may be divided into radio frequency areas covering definable sections of the city or town. In one embodiment, the sections may contain up to five hundred homes and each area may be assigned a reference name. Each area may then be subdivided into zones consisting of clusters, which may be, for example, of up to one hundred homes, with each zone having a zone number. Finally, each zone may be divided into blocks of, for example, approximately ten homes that are also assigned a reference number. Maps may then be created that show each area, zone, and block, and damage assessment forms may be created for each residential address. A staff member or community volunteer may prepare the maps and damage assessment forms. The area maps with instructions may be distributed to area coordinators, while the zone maps with instructions are attached to the first-to-arrive clipboards 120A, and the block maps with damage assessment forms for each address in the block are attached to the volunteer clipboards 120B, all of which are appropriately hung on the rod 122 inside the hub box 102.

In addition to solving the gathering location problem, as found in typical disaster response programs, the disaster relief hub box system 100 may need only one trained area coordinator for each radio frequency area of up to five hundred homes to function at a basic level. The trained individual may be a public safety professional or selected from among the residents of the community. The area coordinator may act as a liaison between an emergency operations center and citizen volunteers communicating the results of the damage assessments to public safety personnel and relaying instructions back to the citizen volunteers directing their stabilization activities. Area coordinators are generally equipped with, and trained to use, the same radio as those in the hub boxes 102 within their radio frequency area and are able to communicate with any of their hub locations. If necessary, area coordinators may also possess and be trained to use a public safety radio to communicate back-and-forth with the emergency operations center.

The disaster relief hub box system 100 may further include zone leaders who manage the hub boxes 102 and direct post-event damage assessments and stabilization efforts within their zones, and block captains or neighborhood coordinators who conduct pre-event asset inventories and mobilize those assets post event. However, none of the coordinators discussed above are essential for a satisfactory disaster response to occur as long as community residents know where the hub box 102 is located in their neighborhood, and that they should go there after a disaster strikes to provide meaningful help and relief to public safety personnel.

Accordingly, a system and method for responding to a disaster scenario comprises a plurality of hub box systems 100 located throughout communities, each hub box 102 accessible without a key and containing a radio 114 and one or more sets of instructions 124, 128, 132 to those who arrive. Because each hub box 102 is easily located within neighborhoods, is not restricted by key, and provides instructions and components to those who are in need, the problems in the prior art have been solved.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A disaster relief hub box system, comprising:
a plurality of hub boxes distributed throughout a community, each hub box comprising:
a first set of instructions on the exterior of the hub box;
a hinged door;
at least one sensor configured to detect when the hinged door is opened;
a two-way communications radio tethered to the interior of the hub box;
a second set of instructions located on the interior of the hub box;
a first clipboard comprising a third set of instructions; and
a plurality of second clipboards comprising a fourth set of instructions.

2. The disaster relief hub box system of claim 1, wherein each hub box further comprises an alarm configured to activate when the hinged door is opened.

3. The disaster relief hub box system of claim 1, wherein each hub box further comprises a micro surveillance camera.

4. The disaster relief hub box system of claim 1, wherein each hub box further comprises a light configured to illuminate when the hinged door is opened.

5. The disaster relief hub box system of claim 1, wherein each hub box further comprises one or more solar panels.

6. The disaster relief hub box system of claim 1, wherein the at least one sensor is one or more of: a motion detection sensor, a light detection sensor, a magnetic sensor, or an accelerometer.

7. The disaster relief hub box system of claim 1, wherein each hub box further comprises an LED for indicating battery status.

8. A disaster relief hub box system, comprising:
a plurality of hub boxes distributed throughout a community, each hub box comprising:
a first set of instructions on the exterior of the hub box, the first set of instructions comprising information about the hub box and its purpose and use;
a hinged door;
at least one sensor configured to detect when the hinged door is opened,
the sensor activating an alarm when the door is opened;
a light configured to illuminate the contents of the hub box;
a two-way communications radio tethered to the interior of the hub box;
a second set of instructions located on the interior of the hub box, the second set of instructions comprising information about how to use the contents of the hub box;
a first clipboard comprising a third set of instructions, the third set of instructions providing information to the first-to-arrive individual at the hub box; and
a plurality of second clipboards comprising a fourth set of instructions, the fourth set of instructions providing information to each subsequent individual to arrive at the hub box;

9. The disaster relief hub box system of claim 8, wherein each hub box further comprises a micro surveillance camera.

10. The disaster relief hub box system of claim 8, wherein each hub box further comprises one or more solar panels.

11. The disaster relief hub box system of claim 8, wherein the at least one sensor is one or more of: a motion detection sensor, a light detection sensor, a magnetic sensor, or an accelerometer.

12. The disaster relief hub box system of claim 8, wherein each hub box further comprises an LED on the exterior for indicating battery status of the two-way radio.

13. A method of using a disaster relief hub box system, the method comprising:
distributing a plurality of hub boxes in a community, each hub box coupled to a pole or structure that is publicly accessible;
providing a first set of instructions on an exterior of each hub box, the first set of instructions explaining the purpose and use of the hub box;
providing a second set of instructions on an interior of the hub box, the second set of instructions explaining how to use the contents of the hub box;
providing a third set of instructions on a first clipboard for use by the first individual to arrive at the hub box;
providing a fourth set of instructions on a plurality of second clipboards, each second clipboard distributed to volunteers;
wherein each volunteer uses the fourth set of instructions to assess one or more structures in a predefined area and reports back to the first individual to arrive with the first clipboard;
the first individual to arrive communicating the assessment to others using a two-way radio located within the hub box.
